(19) United States
(12) Patent Application Publication
(10) Pub. No.: US 2025/0338042 A1
(43) Pub. Date: Oct. 30, 2025

(54) PHOTOELECTRIC CONVERSION APPARATUS AND EQUIPMENT

(71) Applicant: CANON KABUSHIKI KAISHA, Tokyo (JP)

(72) Inventors: TARO MURAKI, Kanagawa (JP); TAKANORI SUZUKI, Tokyo (JP)

(21) Appl. No.: 19/184,054

(22) Filed: Apr. 21, 2025

(30) Foreign Application Priority Data
Apr. 30, 2024 (JP) 2024-074044
Jan. 10, 2025 (JP) 2025-004336

(51) Int. Cl. H04N 25/78; H04N 25/767; H04N 25/771; H04N 25/773; H04N 25/779

(52) U.S. Cl. CPC H04N 25/78; H04N 25/767; H04N 25/771; H04N 25/773; H04N 25/779

(57) ABSTRACT

A photoelectric conversion apparatus includes at least two pixels; and a processing circuit. The processing circuit includes at least two comparator circuits configured to perform a first operation of comparing a pixel signal from a corresponding one of the at least two pixels with a threshold, at least two holding circuits configured to hold a result of the first operation, and at least two setting units. The at least two holding circuits holds the result of the first operation of a corresponding comparator circuit. The result of the first operation is transferred from the at least two holding circuits to a corresponding setting unit via a common signal line. The at least two setting units sets an operation state of the processing circuit in accordance with the result of the first operation.

### BACKGROUND OF THE INVENTION

### Field of the Invention

The present invention relates to a photoelectric conversion apparatus and equipment using the photoelectric conversion apparatus.

### Description of the Related Art

There is provided a technique of arranging an analog-to-digital converter for each column of pixels arranged in a matrix and performing A/D conversion using a ramp signal. Japanese Patent Laid-Open No. 2013-251677 discloses an image capturing apparatus that performs A/D conversion using two ramp signals whose voltages change differently with time.

If two ramp signals are used to perform A/D conversion by simultaneously reading out signals from a plurality of pixels in order to, for example, speed up the A/D conversion, this may further increase the number of wirings.

### SUMMARY OF THE INVENTION

The present invention has been made in consideration of the above-described disadvantage, and can provide a technique advantageous in suppressing an increase in number of wirings while speeding up readout of pixel signals.

According to one aspect of the disclosure, there is provided a photoelectric conversion apparatus. The photoelectric conversion apparatus includes at least two pixels; and a processing circuit. The processing circuit includes at least two comparator circuits each configured to perform a first operation of comparing a pixel signal from a corresponding one of the at least two pixels with a threshold, at least two holding circuits each configured to hold a result of the first operation, and at least two setting units. Each of the at least two holding circuits holds the result of the first operation of a corresponding comparator circuit among the at least two comparator circuits. The result of the first operation is transferred from each of the at least two holding circuits to a corresponding setting unit among the at least two setting units via a common signal line. Each of the at least two setting units sets an operation state of the processing circuit in accordance with the result of the first operation.

Further features of the present invention will become apparent from the following description of exemplary embodiments (with reference to the attached drawings).

### BRIEF DESCRIPTION OF THE DRAWINGS

FIG. 1 is a schematic view of a photoelectric conversion apparatus according to the first embodiment;

FIG. 2 is a view showing a comparative example of an A/D converter using two ramp signals;

FIG. 3 is a timing chart for explaining A/D conversion;

FIG. 4 is a timing chart for explaining A/D conversion;

FIG. 5 is a timing chart for explaining A/D conversion according to the first embodiment;

FIG. 6 is a view showing a comparative example of the photoelectric conversion apparatus;

FIG. 7 is a schematic view of a photoelectric conversion apparatus according to the second embodiment;

FIG. 8 is a schematic view of a photoelectric conversion apparatus according to the third embodiment;

FIG. 9 is a timing chart for explaining A/D conversion according to the third embodiment; and

FIG. 10 is a view showing an example in which the photoelectric conversion apparatus according to each embodiment is applied to equipment.

### DESCRIPTION OF THE EMBODIMENTS

Hereinafter, embodiments will be described in detail with reference to the attached drawings. Note, the following embodiments are not intended to limit the scope of the claimed invention. Multiple features are described in the embodiments, but limitation is not made to an invention that requires all such features, and multiple such features may be combined as appropriate. Furthermore, in the attached drawings, the same reference numerals are given to the same or similar configurations, and redundant description thereof is omitted.

In each embodiment to be described below, an image capturing apparatus will mainly be described as an example of a photoelectric conversion apparatus. However, each embodiment is not limited to the image capturing apparatus and is applicable to other examples of the photoelectric conversion apparatus. Examples are a distance measurement apparatus (an apparatus for distance measurement using Time Of Flight (TOF) or focus detection), and a photometric apparatus (an apparatus for measuring an incident light amount or the like).

In the following embodiments, connection between elements of a circuit may be described. In this case, even if another element intervenes between elements of interest, it is considered that the elements of interest are connected, unless otherwise specified. For example, assume that an element A is connected to one node of a capacitive element C having a plurality of nodes, and an element B is connected to another node. In this case as well, it is considered that the elements A and B are connected, unless otherwise specified.

In addition, an amplifier that outputs a signal obtained by amplifying an input signal is described in this specification, but amplification is not always limited to the form in which a signal amplitude is increased. That is, amplification is a concept including attenuation of a signal, and the amplification factor of the amplifier may be smaller than 1. This specification describes an analog-to-digital converter (A/D converter) that converts an analog signal into a digital signal, but a conversion rate from the analog signal into the digital signal can be handled as the amplification factor. That is, in A/D conversion for an analog signal of the same signal level, it can be said that the amplification factor of the A/D converter is higher in a case where a digital signal of a large value is generated than in a case where a digital signal of a small value is generated.

### First Embodiment

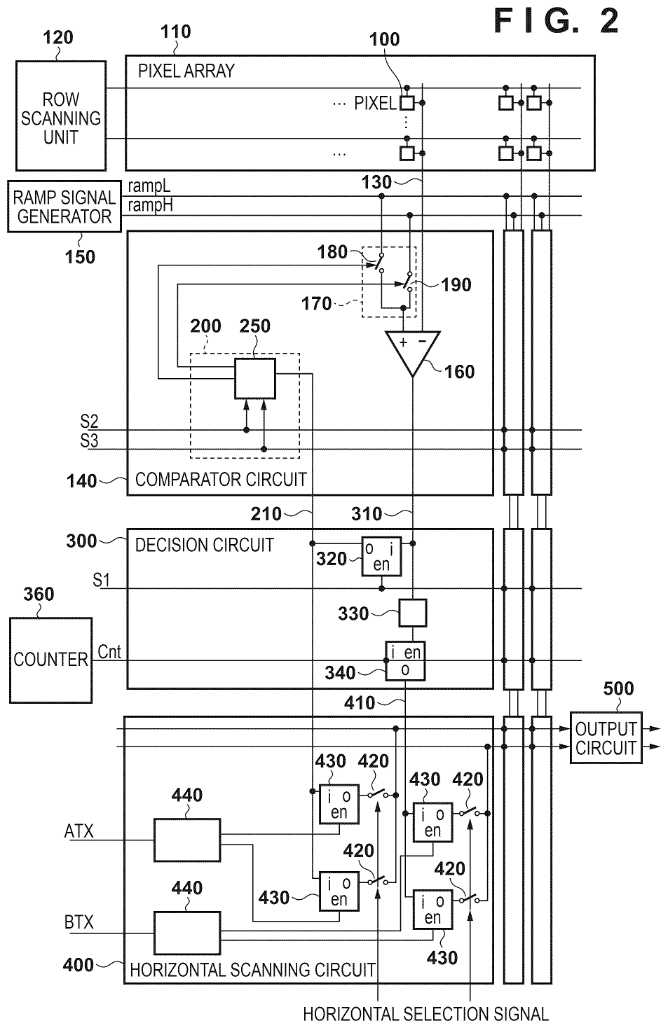

Prior to a description of the first embodiment, A/D conversion using, as reference signals that change at different change rates with time, two ramp signals whose voltages change at different change rates with the lapse of time will be described with reference to an example shown in FIG. 2. The ramp signal is a reference signal whose voltage value changes with the lapse of time. The change is not limited to the form of a slope and includes, for example, the form in which the voltage value changes stepwise. That is, the change of the voltage value includes the form in which the voltage value continuously increases or decreases, and the form in which the increase or decrease of the voltage value and the stop of the change of the voltage value are continuously repeated.

The photoelectric conversion apparatus includes pixels 100, a pixel array 110 in which the pixels 100 are arranged in a matrix, a row scanning unit 120, and vertical signal lines 130. In addition, as components related to analog-to-digital (A/D) conversion, a comparator circuit 140, a ramp signal generator 150, a decision result transfer line 210, a decision circuit 300, and a counter 360 are provided. An output unit including a horizontal scanning circuit 400 and an output circuit 500 can be provided to output A/D-converted data. The pixel 100 includes a photoelectric conversion unit including a photoelectric conversion element, a floating diffusion that converts, into a potential, charges accumulated in accordance with light entering the photoelectric conversion element, a transfer transistor that transfers the converted potential to the vertical signal line 130, and an amplification transistor.

The comparator circuit 140 includes a comparator 160, a switching unit 170, and a selection unit 200. The switching unit 170 includes switches 180 and 190. The selection unit 200 includes a logic circuit 250. The decision circuit 300 includes a holding circuit 320, a pulse generator 330, and a memory 340. The horizontal scanning circuit 400 includes horizontal transfer selection switches 420, transfer memories 430, and logic circuits 440. Two ramp signals rampL and rampH whose voltages change at different change rates and whose slopes are different from each other are output from the ramp signal generator 150. Here, the slope of ramp signal rampL with the lapse of time is smaller than the slope of ramp signal rampH with lapse of time.

The counter 360 counts the clock, and outputs a count signal cnt corresponding to the counted count value. Control signals S2 and S3 are input to the selection unit 200 that selects one of the ramp signals rampL and rampH at the time of A/D conversion. A control signal S1 that controls the holding circuit 320 is supplied to the decision circuit 300, and transfer signals ATX and BTX that control the transfer memories 430 and horizontal selection signals are supplied to the horizontal scanning circuit 400. An output from the comparator 160 is output to the decision circuit 300 via a comparator output line 310. An output from the memory 340 is output to an A/D result output line 410.

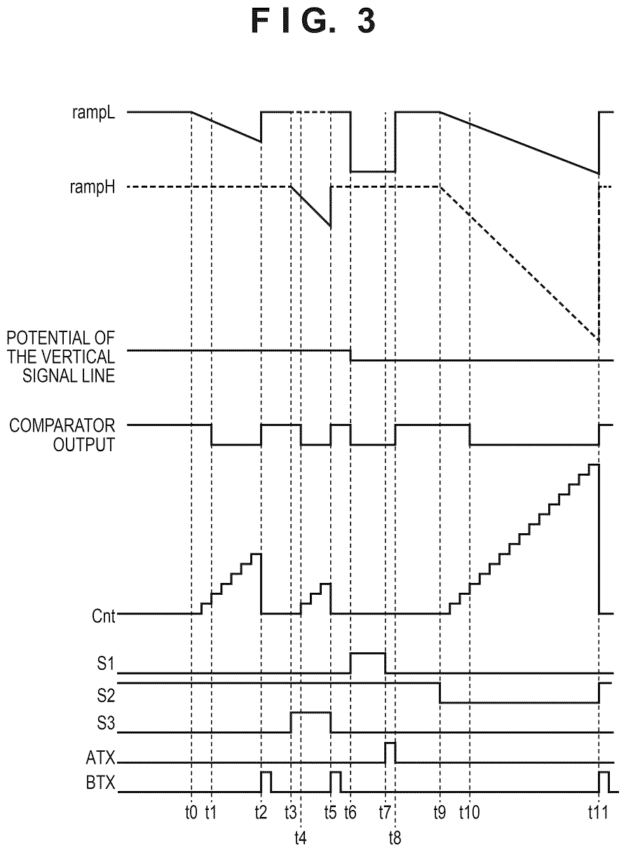

An A/D conversion operation executed in the example shown in FIG. 2 in a case where a pixel signal output from the pixel 100 to the vertical signal line 130 is at a level corresponding to low luminance will be described next with reference to FIG. 3. The potential at a reset level of the pixel is A/D-converted during a period from time t0 to time t2. A signal at a noise level can be obtained by the A/D conversion. Note that the pixel 100 is initially reset.

At time t0, the control signals S2 and S3 are controlled at H level and L level, respectively. When the control signal S2 is set at H level, the selection unit 200 is set in a selectable state by the control signal S3. When the control signal S3 is set at L level, the switching unit 170 is controlled to turn on the switch 180 and turn off the switch 190. By controlling the switching unit 170 by the selection unit 200, the ramp signal rampL is selected. Thus, the ramp signal rampL is input to the noninverting input terminal of the comparator 160.

At this time, the pixel 100 is reset, and the potential of the vertical signal line 130 is at a level corresponding to the reset level of the pixel 100. That is, the potential of the vertical signal line 130 indicates the noise level. At this time, since the relationship of the potential of the noninverting input terminal of the comparator 160 is higher than the potential of the inverting input terminal of the comparator 160 holds, the output from the comparator 160 is at H level. After time t0, the potential of the ramp signal rampL lowers, and the count signal cnt is counted up. When the ramp signal rampL becomes lower than the potential of the vertical signal line 130 at time t1, the output from the comparator 160 transitions from H level to L level, and the pulse generator 330 that has received the output from the comparator 160 generates a one-shot pulse for a short time, and supplies it to the memory 340.

With the one-shot pulse, the value of the count signal cnt of the counter 360 at time t1 is written in the memory 340. Note that with respect to the relationship between the potentials of the ramp signal rampL and the vertical signal line 130, this embodiment has explained that when the potential of the ramp signal rampL becomes lower than the potential of the vertical signal line 130, the output from the comparator 160 transitions. However, by reversing the change of the ramp signal rampL, the output from the comparator 160 can transition when the potential of the ramp signal becomes higher than the potential of the vertical signal line 130. For example, there can be provided an arrangement in which an amplifier that inverts and amplifies the signal of the vertical signal line 130 is provided and an output from the amplifier is given to the comparator 160. In this arrangement, the signal input to the comparator 160 has a higher voltage value as light entering the pixel increases, due to inverting amplification by the amplifier. In this case, the ramp signals rampL and rampH can be signals whose voltage values change to increase with the lapse of time.

The count signal cnt written in the memory 340 is a count value corresponding to the magnitude of the analog signal. This count value is data of the result of A/D conversion for the reset level, using the ramp signal rampL. At time t2, the ramp signal rampL and the count signal cnt are reset, and the output from the comparator 160 returns from L level to H level. The data of the A/D conversion result written at time t1 is written from the memory 340 into the selected transfer memory 430 by the logic circuit 440 that has received the transfer signal BTX at time t2. The horizontal transfer selection switch 420 is controlled by the horizontal selection signal to select the transfer memory 430, and the selected data is transferred to the output circuit 500.

After that, at time t3, the control signal S3 is switched to H level. Thus, the selection unit 200 controls the switching unit 170 to turn off the switch 180 and turn on the switch 190. This inputs the ramp signal rampH to the noninverting input terminal of the comparator 160 via the switch 190. After time t3, the potential of the ramp signal rampH lowers, and during this period, the counter 360 counts up and outputs the count value as the count signal cnt. When the ramp signal rampH becomes lower than the potential of the vertical signal line 130 at time t4, the output from the comparator 160 transitions to L level, and the pulse generator 330 generates a one-shot pulse. The one-shot pulse is supplied to the memory 340. With this operation, at time t4, the count signal cnt is written in the memory 340.

The count signal cnt written in the memory 340 is a count value corresponding to the magnitude of the analog signal. This count value is the result of A/D conversion using the ramp signal rampH for the reset level. At time t5, the control signal S3 is set at L level, the ramp signal rampL and the count signal cnt are reset, and the output from the comparator 160 returns from L level to H level. At time t5, the written A/D conversion result is written from the memory 340 into the selected transfer memory 430 by the logic circuit 440 that has received the transfer signal BTX. The horizontal transfer selection switch 420 is controlled by the horizontal selection signal to select the transfer memory 430, and the selected data is transferred to the output circuit 500. When the control signal S3 returns to L level at time t5, the ramp signal rampL is input again to the noninverting input terminal of the comparator 160.

At time t6, a pixel signal corresponding to charges that are accumulated in the photoelectric conversion element of the photoelectric conversion unit, for example, a photodiode in accordance with incident light in the pixel 100 is transferred to the vertical signal line 130. At this time, the potential of the vertical signal line 130 is at a level corresponding to a low-luminance optical signal. At this timing, the potential of the ramp signal rampL is made lower to a predetermined threshold voltage, and the level of the vertical signal line 130 is decided. In this embodiment, the ramp signal can be selected in accordance with whether the potential is higher or lower than the threshold voltage (threshold). Note that this threshold is preferably set to a voltage whose amplitude is smaller than that of a reaching voltage which the ramp signal rampL whose potential changes after time t9 reaches at time t11 in A/D conversion of the pixel signal (to be described later).

Note that in this specification, the amplitude is considered as the absolute value of the difference between the reference voltage value of the change and the changed voltage. That is, in this embodiment, the voltage whose amplitude is smaller than that of the reaching voltage of the ramp signal rampL indicates a voltage having a voltage value higher than the reaching voltage of the ramp signal rampL. By setting the threshold in this way, it is possible to ensure the A/D conversion accuracy with respect to a pixel signal at a level around the reaching voltage of the ramp signal rampL. If the threshold is set to the same value as the reaching voltage of the ramp signal rampL, the ramp signal rampL can be selected in deciding the level of the vertical signal line 130. However, if, in A/D conversion thereafter, the amplitude of the vertical signal line 130 becomes large due to external noise, a variation of a power supply voltage, or the like. The amplitude of the vertical signal line 130 can exceed the reaching voltage of the ramp signal rampL.

In this case, the output from the comparator 160 remains unchanged, and it is difficult to correctly perform A/D conversion. By setting the threshold to the voltage whose amplitude is smaller than that of the reaching voltage of the ramp signal rampL, it can be decided to use the ramp signal rampH for the signal level of the vertical signal line 130 around the reaching voltage of the ramp signal rampL. This can appropriately perform A/D conversion even for a signal at a level around the reaching voltage of the ramp signal rampL.

Since FIG. 2 shows a case where incident light has low luminance, the potential of the vertical signal line 130 is higher than the threshold voltage of the ramp signal rampL and the output from the comparator 160 is at L level. At this time, the control signal S1 is set at H level during a period from time t6 to time t7 to allow writing in the holding circuit 320, and L level as the decision result of the comparator 160 is written in the holding circuit 320.

During a period from time t7 to time t8, the logic circuit 440 that has received the transfer signal ATX writes the decision result in the transfer memory 430. By returning the ramp signal rampL to the start level of the ramp signal rampL at time t8, the output from the comparator 160 returns to H level.

Then, by setting the control signal S2 at L level at time t9, the selection unit 200 is allowed to be controlled by the output from the holding circuit 320. At this time, the decision result written in the holding circuit 320 can be supplied to the selection unit 200. During the period from time t6 to t7, L level is written in the holding circuit 320. The selection unit 200 controls the switching unit 170 in accordance with the signal at L level from the holding circuit 320 to turn on the switch 180 and turn off the switch 190. As a result, the ramp signal rampL can be input to the noninverting input terminal of the comparator 160. At this time, the selection unit 200 functions as a setting unit that selects the ramp signal, supplies it to the comparator, and sets the operation state of A/D conversion.

From time t9, A/D conversion of the pixel signal corresponding to the low-luminance incident light is performed. From time t9, the potential of the ramp signal rampL lowers, and the count signal cnt is counted up. At time t10, the potential of the ramp signal rampL becomes lower than the potential of the vertical signal line 130. When the comparator output transitions to L level at time t10, the result of A/D conversion using the ramp signal rampL for the signal level is written in the memory 340. At time t11, the ramp signal rampL and the count signal cnt are reset.

From time t11, the AD conversion result written in the memory 340 at time t10 is written in the transfer memory 430 selected by the logic circuit 440 that has received the transfer signal BTX. The decision result with the reference signal and the result of the A/D conversion of the pixel signal, which have been written in the transfer memory 430, are horizontally transferred to the output circuit 500 by selecting the horizontal transfer selection switch 420 by the horizontal selection signal. The output circuit 500 performs processing such as “S-N processing” of subtracting data at the noise level from the data of the pixel signal based on the A/D conversion result horizontally transferred from the transfer memory 430. After performing the processing, the output circuit 500 outputs a signal. At this time, the output circuit can add different processing for the A/D conversion result in accordance with the decision result. This will be described later.

As described above, in a case where the signal level of the pixel signal in the vertical signal line 130 corresponds to low luminance, it is possible to reduce random noise caused by a quantization error or the like by selecting and using the ramp signal rampL with a smaller slope, thereby performing accurate A/D conversion.

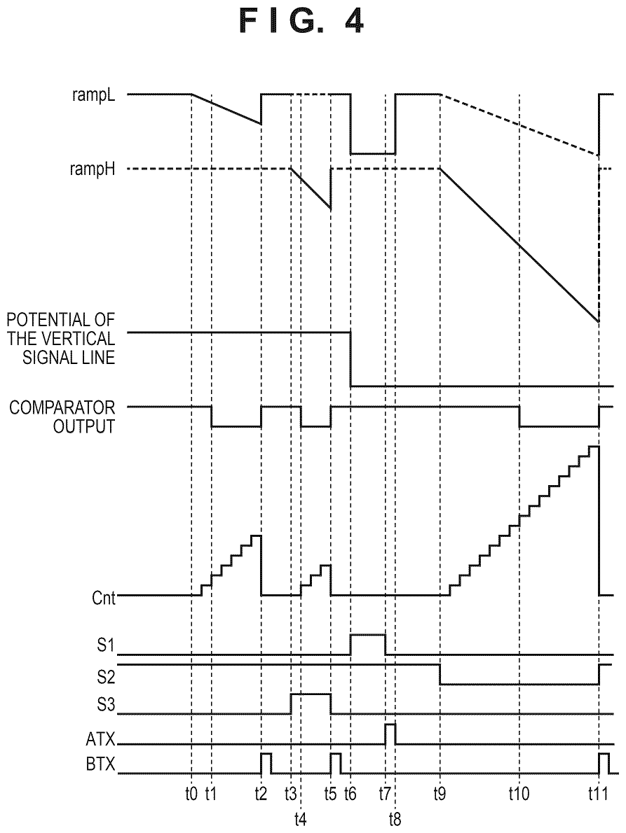

An A/D conversion operation executed in FIG. 2 in a case where the signal level output from the pixel 100 to the vertical signal line 130 corresponds to high luminance will be described next with reference to FIG. 4. Operations up to A/D conversion at the noise level at time t6 are the same as in FIG. 3. At time t6, a pixel signal corresponding to charges that are accumulated in the photoelectric conversion unit in accordance with incident light in the pixel 100 is transferred to the vertical signal line 130. At this time, the potential of the vertical signal line 130 is at a level corresponding to a high-luminance optical signal. At this timing, the potential of the ramp signal rampL is made lower to the predetermined threshold voltage, and the level of the vertical signal line 130 is decided. In this embodiment, the ramp signal can be selected in accordance with whether the potential is higher or lower than the threshold voltage.

Since FIG. 4 shows a case where incident light has high luminance, the threshold voltage by the ramp signal rampL is higher than the potential of the vertical signal line 130 and the output from the comparator 160 remains at H level without changing. At this time, the control signal S1 is set at H level during the period from time t6 to time t7 to allow writing in the holding circuit 320, and H level as the decision result of the comparator 160 is written in the holding circuit 320.

The ramp signal to be used to perform A/D conversion of the pixel signal is decided during a period from time t6 in which the signal level of the vertical signal line 130 is compared with the threshold voltage to make a decision. The result written in the holding circuit 320 changes in accordance with the decision result. At time t8, the transfer signal ATX falls, and the decision result is stored in the transfer memory 430. By setting the control signal S2 at L level at time t9, the selection unit 200 is allowed to be controlled by the output from the holding circuit 320. H level is written in the holding circuit 320. The selection unit 200 controls the switching unit 170 in accordance with the signal at H level from the holding circuit 320 to turn off the switch 180 and turn on the switch 190. As a result, the ramp signal rampH can be input to the noninverting input terminal of the comparator 160.

A/D conversion using the ramp signal rampH can be executed from time t9. Since the potential of the ramp signal rampH becomes lower than the potential of the vertical signal line at time t10, the comparator output from the comparator 160 transitions from H level to L level, and the pulse generator 330 generates a one-shot pulse in response to the transition of the output from the comparator 160. With the one-shot pulse, the value of the count signal cnt of the counter 360 is written in the memory 340. From time t11, the AD conversion result written in the memory 340 at time t10 is written in the transfer memory 430 selected using the signal BTX and the logic circuit 440. The decision result with the threshold voltage and the A/D conversion result, which have been written in the transfer memory 430, may be horizontally transferred to the output circuit 500 by selecting the horizontal transfer selection switch 420 by the horizontal selection signal.

At this time, the output circuit 500 may perform “S-N processing” of subtracting data at the noise level from data corresponding to the pixel signal based on the decision result of the holding circuit 320. Furthermore, the output circuit 500 may output a signal obtained after performing processing of, for example, multiplying a gain in accordance with the ratio of the slopes of the ramp signals rampL and rampH. In addition, the output circuit 500 can perform processing such as correction of an offset difference generated by deviation of a propagation delay or an operation start timing between the ramp signals rampL and rampH.

As described above, in a case where the signal level of the vertical signal line 130 corresponds to high luminance, the ramp signal rampH with a larger slope is selected and used. This increases random noise caused by a quantization error or the like in A/D conversion, but optical shot noise appearing on the side of the vertical signal line 130 is dominant, and it is thus possible to shorten the readout time while minimizing influence on total random noise.

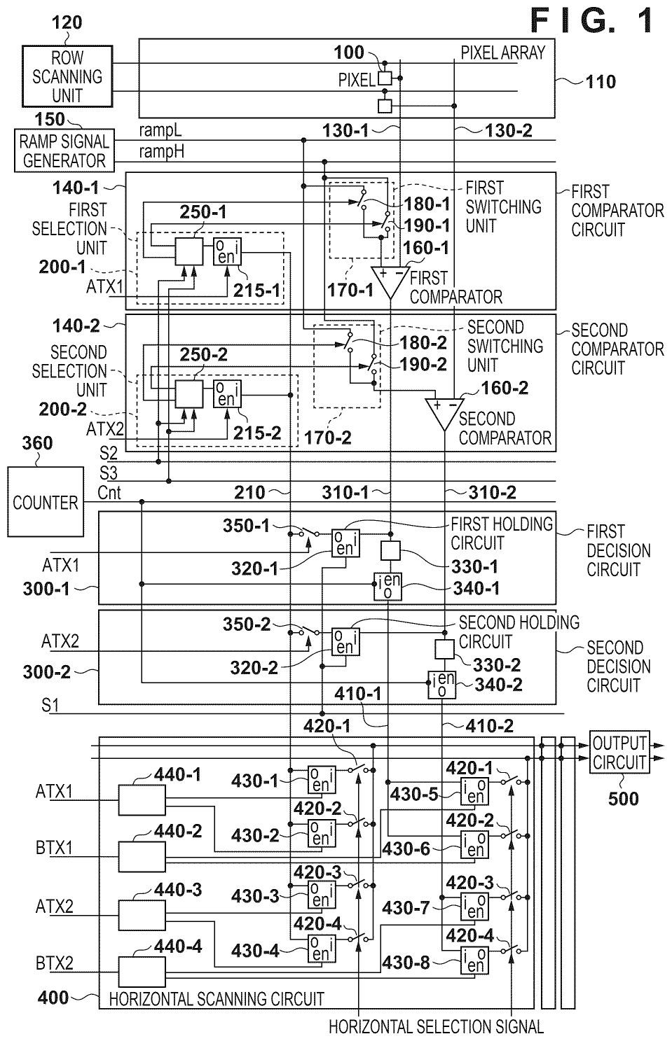

This embodiment will be described next with reference to FIG. 1. The difference from FIG. 2 will be described. In an example of a photoelectric conversion apparatus shown in FIG. 1, to quickly read out signals from the pixels 100, processing of simultaneously reading out the signals from the pixels 100 arranged in two rows in the pixel array 110 is performed. To do this, two comparator circuits of a first comparator circuit 140-1 and a second comparator circuit 140-2 and two decision circuits of a first decision circuit 300-1 and a second decision circuit 300-2 are arranged in a column direction. An example of simultaneously reading out two rows will be described here, but the number of rows, a difference in column, and the number of pixels to be read out simultaneously are not limited.

Note that when explaining any one of components with the same name that are added with numbers such as “first” and “second”, the numbers such as “first” and “second” may be omitted. In addition, components with suffix numbers such as “300-1” and “300-2” will sometime be described by omitting “-1” and “-2” of reference numerals.

A first serial transfer switch 350-1 and a second serial transfer switch 350-2 are arranged in the first decision circuit 300-1 and the second decision circuit 300-2, respectively. The decision result transfer line 210 is commonly used by the two decision circuits 300 and the two comparator circuits 140. In other words, the decision result transfer line 210 is shared by the plurality of decision circuits 300 and the plurality of comparator circuits 140. Each of two selection units 200 includes a memory 215. Transfer signals ATX1, ATX2, BTX1, and BTX2 are input to the horizontal scanning circuit 400. In addition, the transfer signal ATX1 is input to the first comparator circuit 140-1 and the first decision circuit 300-1. The transfer signal ATX2 is input to the second comparator circuit 140-2 and the second decision circuit 300-2.

The serial transfer switches 350-1 and 350-2 connect the outputs of holding circuits 320-1 and 320-2 and the decision result transfer line 210, respectively. The switches 350-1 and 350-2 are controlled by the transfer signals ATX1 and ATX2, respectively. A memory 215-1 of a first selection unit 200-1 receives the decision result transfer line 210, and latches and stores the level of the decision result transfer line 210 at the falling edge of the transfer signal ATX1. A memory 215-2 of a second selection unit 200-2 receives the decision result transfer line 210, and latches and stores the level of the decision result transfer line 210 at the falling edge of the transfer signal ATX2. Readout from each memory 215 can be controlled by the logic circuit 250.

Each of the first comparator circuit 140-1, the second comparator circuit 140-2, the first decision circuit 300-1, and the second decision circuit 300-2 can be referred to as a circuit block. The decision result transfer line 210 is shared among the circuit blocks. The decision result transfer line 210 is also connected to the input of the transfer memory 430 of the horizontal scanning circuit 400. The signal of the decision result transfer line 210 is stored in one of transfer memories 430-1 to 430-4 selected by the logic circuit 440 and the transfer signal ATX1 or ATX2. Furthermore, the output unit including the horizontal scanning circuit 400 and the output circuit 500 is provided to output A/D-converted data. In this embodiment, the decision circuits and the comparator circuits can be regarded as a processing circuit that processes the pixel signals.

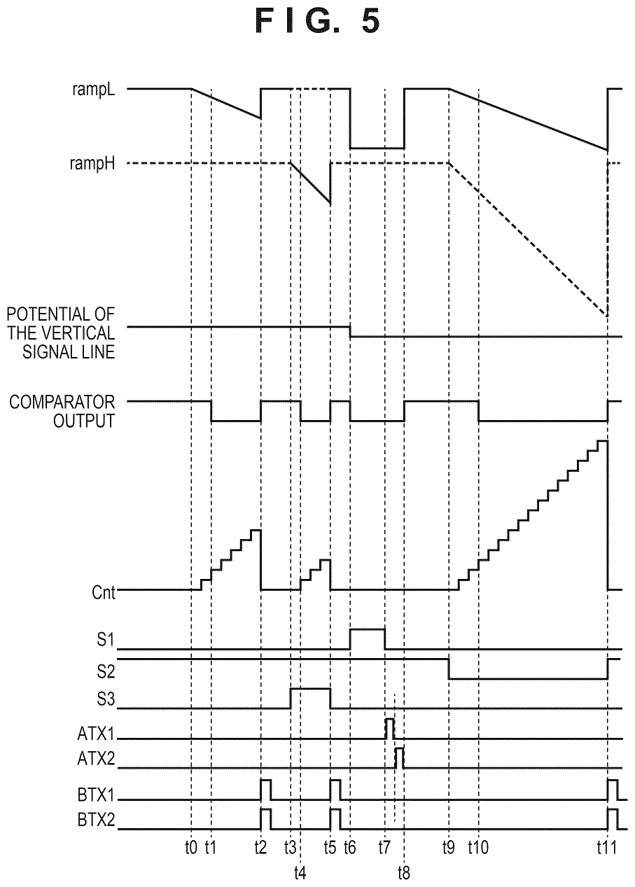

An operation according to this embodiment will be described next with reference to FIG. 5. As described with reference to FIG. 3, an operation in a case where incident light has low luminance will be explained. A period from time t0 to time t2 is an A/D conversion period for the reset level by the ramp signal rampL, similar to FIG. 3. The difference is that A/D conversion is executed simultaneously for two pixels using the first comparator circuit 140-1 and the first decision circuit 300-1 and the second comparator circuit 140-2 and the second decision circuit 300-2, respectively.

At time t2, the potentials of the vertical signal lines for the outputs from the two pixels and the results of A/D conversion using the ramp signal rampL are transferred to transfer memories 430-5 and 430-7 using the transfer signals BTX1 and BTX2 and stored, respectively. A/D conversion for the reset level using the ramp signal rampH is performed during a period from time t3 to time t5, and A/D conversion results are transferred to transfer memories 430-6 and 430-8 using the transfer signals BTX1 and BTX2, respectively, at time t5. Note that the decision result with the threshold voltage and data of the A/D conversion result stored in the transfer memory 430 are transferred to the output circuit 500 by the horizontal selection signal. At this time, in accordance with the decision result of the holding circuit 320, the output circuit 500 may perform “S-N processing” of subtracting data at the noise level from data corresponding to the pixel signal. In addition, a signal obtained after performing processing of, for example, multiplying a gain in accordance with the ratio of the slopes of the ramp signals rampL and rampH may be output.

As described with reference to FIG. 3, a period from time t6 to time t8 is a period in which an operation of writing, in the first holding circuit 320-1 and the second holding circuit 320-2, decision results each obtained by comparing the level of the pixel signal with the threshold voltage is performed. At this time, the signal levels of the two pixels are compared with the threshold voltage to make a decision. During a period from time t7 to time t8, the decision results held in the first holding circuit 320-1 and the second holding circuit 320-2 are sequentially transferred to the decision result transfer line 210. Note that this embodiment describes an example of selecting one of the two ramp signals in accordance with the threshold voltage, as in the example shown in FIG. 3, but two or more threshold voltages and three or more slopes of ramp signals may be provided.

During the period from time t7 to time t8, the transfer signals ATX1 and ATX2 are sequentially set at H level. The decision results held in the holding circuits 320-1 and 320-2 are sequentially transferred to the decision result transfer line 210 when the transfer signals ATX1 and ATX2 are set at H level to control to sequentially turn on the serial transfer switches 350-1 and 350-2. The decision results are sequentially transferred from the two decision circuits 300 to the two comparator circuits 140 via the commonly connected decision result transfer line 210.

During the period from time t7 to time t8, the transferred decision result is first stored in the memory 215-1 and the transfer memories 430-1 and 430-2 at the falling edge of the transfer signal ATX1. Next, the transferred decision result is stored in the memory 215-2 and the transfer memories 430-3 and 430-4 at the falling edge of the transfer signal ATX2. The example of storing the decision result using the falling edge of each of the transfer signals ATX1 and ATX2 has been explained, but the rising edge can be used depending on a circuit arrangement. Since the transfer signals ATX1 and ATX2 use the same decision result transfer line 210, the timing of setting the transfer signal at H level is shifted not to turn on the serial transfer switches 350 at the same time.

The logic circuit 250-1 or 250-2 controls the switching unit 170 in accordance with the decision result stored in the memory 215-1 or 215-2 to select the ramp signal. The selected ramp signal is input to the comparator. A/D conversion has been described by exemplifying the two pixels. Since the comparator circuits and the decision circuits are provided in correspondence with the two pixels, as shown in FIG. 1, it is possible to select and set the appropriate ramp signal for each of the two pixels in accordance with the level of the incident light.

This embodiment has explained the example of controlling the serial transfer switches 350 using the transfer signals ATX1 and ATX2. However, the present invention is not limited to this as long as it is possible to sequentially transfer the data of the decision results to the memories 215 and the transfer memories 430 respectively corresponding to the decision results and store the data of the decision results. By performing serial transfer of the decision results, it is possible to reduce the number of decision result transfer lines 210 when the plurality of comparator circuits and the plurality of decision circuits are provided in order to speed up readout of the pixel signals.

A period from time t9 is a period in which the ramp signal rampL selected in accordance with the decision result is used to perform A/D conversion of the pixel signals from the two pixels. The decision circuits and the comparator circuits can be regarded as a processing circuit including execution of A/D conversion processing of the pixel signals. As described above, in this embodiment, the ramp signal can be selected in accordance with the magnitude of the pixel signal from the plurality of ramp signals whose voltages change at different change rates with the lapse of time. As a result, the operation state of the processing circuit including the comparator circuits can be changed. The data of the A/D conversion results can be transferred to the transfer memories 430-5 and 430-7 using the transfer signals BTX1 and BTX2 and stored. After that, the data stored in the transfer memory 430 can be output to the output circuit 500.

If the pixel size is reduced in addition to the high-speed operation of reading out the signals from the pixels, the pitch width between columns is decreased. Thus, when circuits are formed by sharing the pitch width among the plurality of columns, arranging the plurality of circuits in the column direction is advantageous in reducing the signal lines in terms of securing the layout area.

In this embodiment, the plurality of decision results decided simultaneously are not transferred at once using the transfer signal ATX but transferred at different timings using the transfer signals ATX1 and ATX2. By transferring the data at different transfer timings and performing memory write operations, peak power generated at a memory write timing can be distributed. This can reduce a voltage variation caused by the peak current of a commonly connected power supply/GND wiring. It is also possible to suppress degradation of image quality.

### Second Embodiment

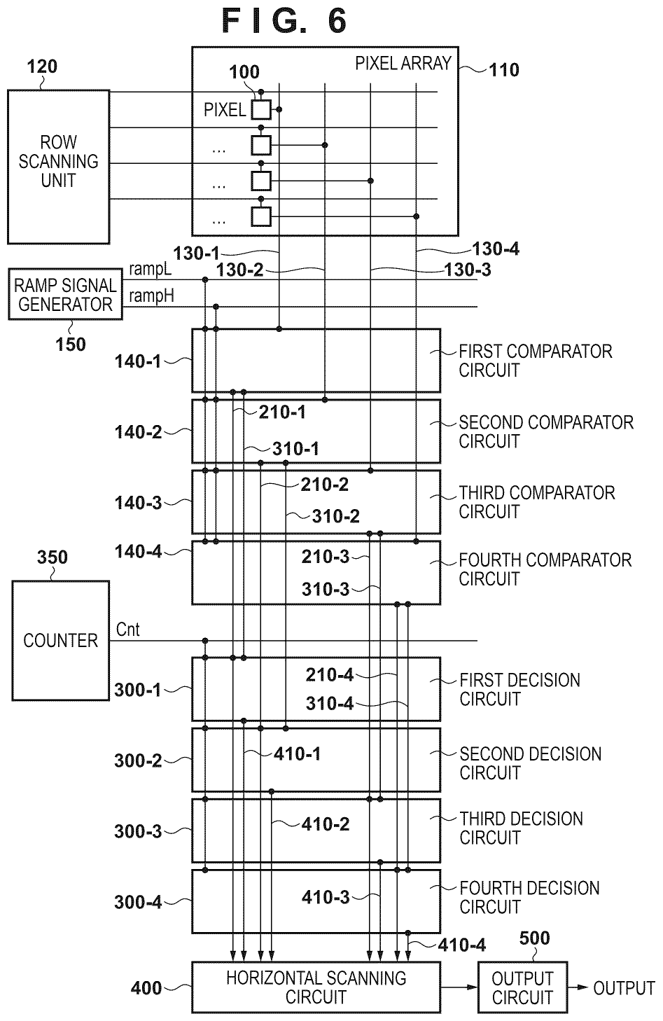

The second embodiment will be described next. Prior to a description of this embodiment, an example of A/D-converting signals from four pixels 100 simultaneously will be described with reference to FIG. 6. FIG. 6 is a schematic view in which a plurality of circuit blocks corresponding to a plurality of pixels are arranged. An operation will be described using an example in which four circuit blocks are arranged in one column in a column direction so as to simultaneously read out signals of the pixels 100 arranged for four rows and perform A/D conversion. In this example as well, assume that A/D conversion is performed using two ramp signals whose voltages change at different change rates with time. In a pixel array 110 in which the plurality of pixels are arranged in a matrix, pixel signals for four rows selected by a row scanning unit 120 are supplied to four comparator circuits 140 via vertical signal lines 130, respectively.

The comparator circuits include four comparator circuits of a first comparator circuit 140-1 to a fourth comparator circuit 140-4. Wirings of ramp signals rampL and rampH from a ramp signal generator 150 are connected to each comparator circuit 140. Similarly, decision circuits 300 the number of which is equal to the number of pixels 100 to be read out simultaneously are necessary, and thus four decision circuits 300-1 to 300-4 are prepared. A counter 360 for A/D conversion is connected to each decision circuit 300.

Decision result transfer lines 210 and comparator output lines 310 as outputs of holding circuits 320 are connected from the four comparator circuits 140 to the four decision circuits 300, respectively. A/D result output lines 410 and the decision result transfer lines 210 are connected between the four decision circuits 300-1 to 300-4 and a horizontal scanning circuit 400. The horizontal scanning circuit 400 sequentially, horizontally transfers received A/D conversion results and decision results to an output circuit 500. The output circuit 500 can perform data processing in accordance with the decision result. The signal having undergone the data processing can externally be output.

In this example, since four comparator circuits and four decision circuits are necessary to read out signals from four pixels simultaneously, the four decision result transfer lines 210 and the four comparator output lines 310, that is, eight lines in total are connected between the comparator circuits and the decision circuits in each column. In addition, the four decision result transfer lines 210 and the four A/D result output lines 410, that is, eight lines in total are connected between the four decision circuits and the horizontal scanning circuit in each column. The example of reading out signals from four pixels simultaneously has been described. To read out signals from eight pixels arranged for eight rows, 16 wirings in total are connected in each column, and the number of wirings in a column increases in proportion to the number of pixels to be read out simultaneously.

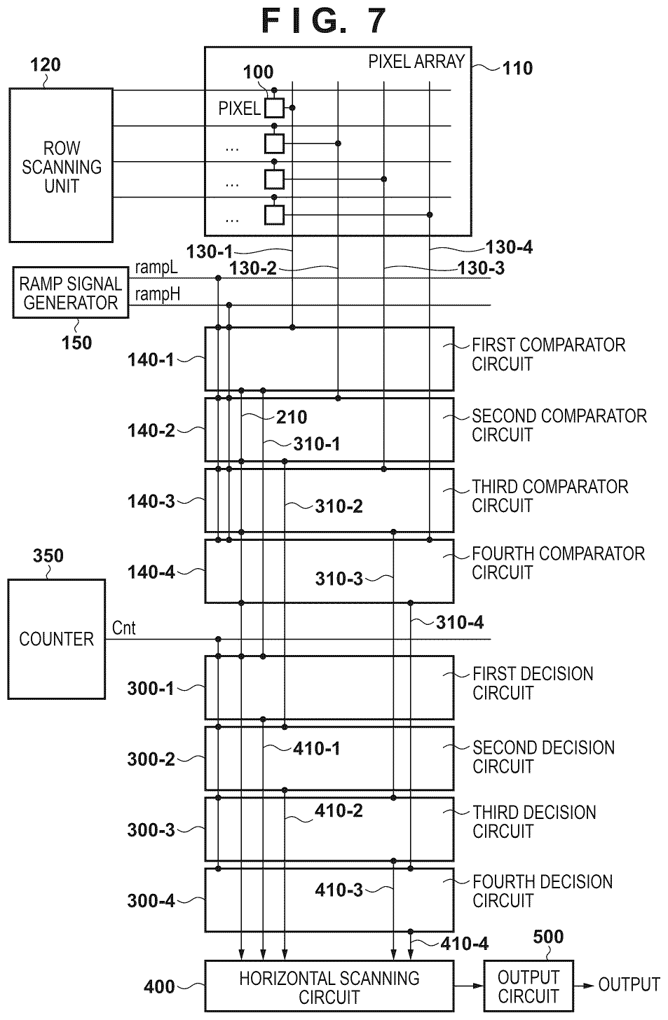

FIG. 7 is a schematic view in which circuit blocks are arranged in the column direction according to this embodiment. Similar to FIG. 6, four circuit blocks are arranged in the column direction. The difference from the example of FIG. 6 will be described. In this embodiment, by performing serial transfer of decision results, the number of decision result transfer lines 210 connected between the four comparator circuits of the first comparator circuit 140-1 to the fourth comparator circuit 140-4 and the four decision circuits of the first decision circuit 300-1 to the fourth decision circuit 300-4 can be one. In addition, the number of comparator output lines 310 can be four. The five wirings in total are connected in one column. As connecting lines between the four decision circuits 300 and the horizontal scanning circuit 400, the one decision result transfer line 210 and the four A/D result output lines, that is, five lines in total are connected in one column. The number of wirings in a column is reduced, as compared with the eight wirings in total in the conventional example.

In this example, the signals of the four pixels arranged for four rows are read out simultaneously. However, in a case where the signals of eight pixels arranged for eight rows are read out simultaneously, nine wirings in total are connected in a column, and the number of wirings is reduced from 16 in total in the conventional example. The larger the number of pixels to be read out simultaneously, the larger the effect of reducing the number of wirings in a column in this embodiment.

### Third Embodiment

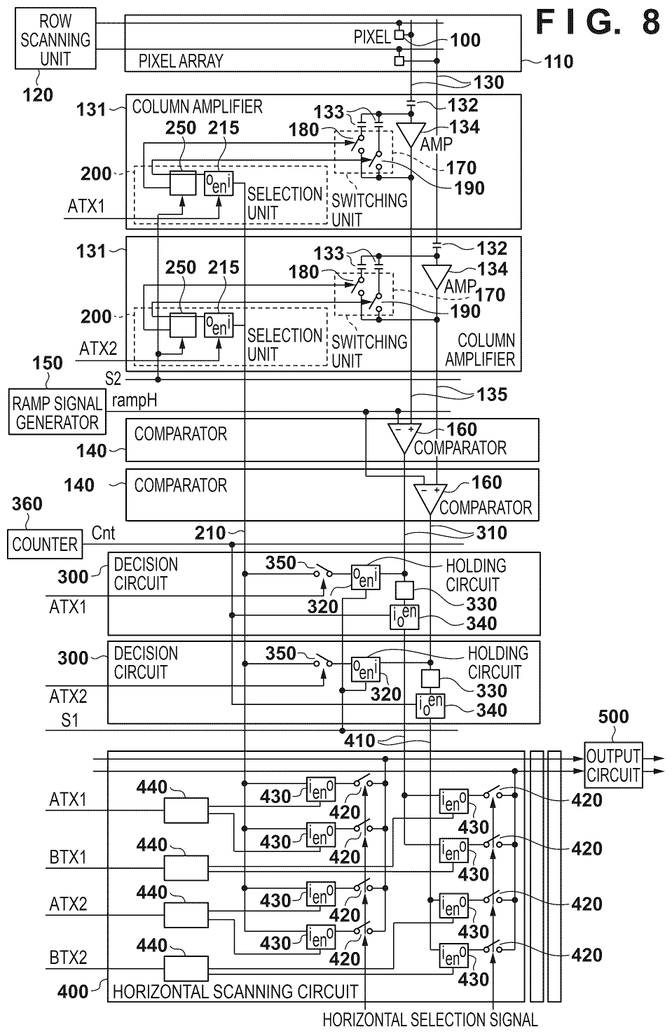

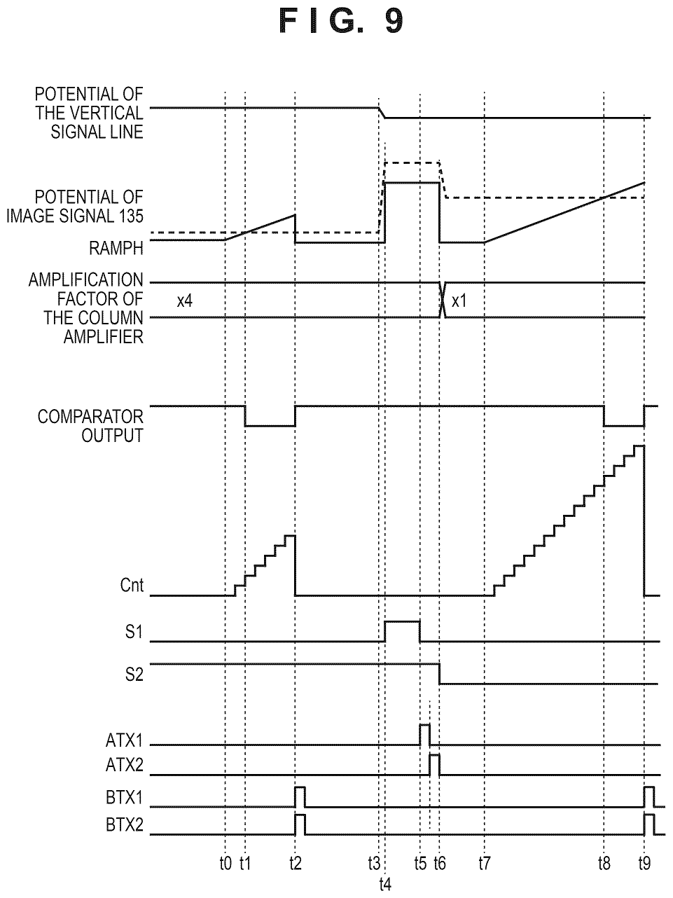

A photoelectric conversion apparatus according to this embodiment will be described with reference to FIGS. 8 and 9. The photoelectric conversion apparatus includes a pixel array 110 described in the first embodiment. In this arrangement, a vertical signal line 130 of the pixel array 110 is connected to one electrode of an input capacitor 132 in a column amplifier 131. The other electrode of the input capacitor 132 is connected to an amplifier 134 and a feedback capacitor 133 of the amplifier 134. In addition, a selection unit 200 is arranged in the column amplifier 131, and includes a memory 215 and a logic circuit 250 as in the first embodiment. The selection unit 200 switches, by switches 180 and 190 of a switching unit 170, the capacitance value of the feedback capacitor 133 that decides the amplification factor of the amplifier 134. The selection unit 200 functions as a setting unit that sets an amplification factor. In this embodiment, the amplifier 134 is an inverting amplifier.

The amplifier 134 inverts and amplifies a vertical signal potential from the vertical signal line 130, and outputs it as an image signal 135. The image signal 135 is input to a comparator circuit 140. In this embodiment, the comparator circuit 140 compares the image signal 135 with a ramp signal rampH generated by a ramp signal generator 150. A comparison result is input from the comparator circuit 140 to a decision circuit 300 via a comparator output line 310. The column amplifier 131 including the amplifier 134, the comparator circuit 140, and the decision circuit 300 can be regarded as a processing circuit including execution of A/D conversion processing of a pixel signal. The remaining components are the same as in the first embodiment.

An operation according to this embodiment will be described next with reference to FIG. 9. An A/D conversion operation executed in FIG. 8 in a case where the signal level of the image signal output from the pixel 100 to the vertical signal line 130 corresponds to high luminance will be described. During a period from time t0 to time t2, the potential at a reset level of the pixel is A/D-converted. With this A/D conversion, data corresponding to a signal at a noise level can be obtained. Note that the pixel 100 is initially reset.

In this embodiment, the amplification factor of the column amplifier is set to 4, and the potential at the reset level is amplified. First, at time t0, the feedback capacitor 133 that decides the amplification factor of the column amplifier is selected by the selection unit 200 to obtain an amplification factor of 4. At this time, the pixel 100 is reset, and the potential of the vertical signal line 130 is at a level corresponding to the reset level of the pixel 100. That is, the potential of the vertical signal line 130 indicates the noise level.

The vertical signal line 130 is input to the amplifier 134 as an inverting amplifier via the input capacitor 132. The image signal 135 as the output signal of the amplifier 134 is connected to the noninverting input terminal of a comparator 160. The potential of the image signal 135 is indicated by an image signal potential by broken line. The ramp signal rampH is input to the inverting input terminal of the comparator 160. Since the potential of the noninverting input terminal of the comparator 160 is higher than the potential of the inverting input terminal at time t0, the output from the comparator 160 is at H level. From time t0, the potential of the ramp signal rampH increases with time. At this time, a count signal cnt is counted up along with the increase in potential of the ramp signal rampH. When the potential of the ramp signal rampH becomes higher than the potential of the image signal 135 at time t1, the output from the comparator 160 transitions from H level to L level, and a pulse generator 330 that has received the output from the comparator 160 generates a one-shot pulse for a short time, and supplies it to a memory 340.

With the one-shot pulse, the value of the count signal cnt of the counter 360 at time t1 is written in the memory 340. Note that with respect to the relationship between the potentials of the ramp signal rampH and the image signal 135, this embodiment has explained that when the potential of the ramp signal rampH becomes higher than the potential of the image signal 135, the output from the comparator 160 transitions. However, by reversing the change of the ramp signal rampH, the output from the comparator 160 can transition when the potential of the ramp signal becomes lower than the potential of the image signal 135.

For example, a noninverting amplifier is used as the amplifier 134, and the image signal of the vertical signal line 130 is input to the noninverting amplifier. The output from the amplifier can be provided to the comparator 160. In this arrangement, the signal input to the comparator 160 has a lower voltage value as light entering the pixel increases, due to noninverting amplification by the amplifier. In this case, the ramp signal rampH can be a signal whose voltage value changes to decrease with the lapse of time.

The count signal cnt written in the memory 340 is a count value corresponding to the magnitude of the analog signal of the image signal 135. This count value is data of the result of A/D conversion using the ramp signal rampH for the reset level amplified with an amplification factor of 4 by the column amplifier 131. At time t2, the ramp signal rampH and the count signal cnt are reset, and the output from the comparator 160 returns from L level to H level. At time t2, the written data of the A/D conversion result is written from the memory 340 into a selected transfer memory 430 by a logic circuit 440 that has received a transfer signal BTX. A horizontal transfer selection switch 420 is controlled by a horizontal selection signal to select the transfer memory 430, and the selected data is transferred to the output circuit 500.

At time t3, a pixel signal corresponding to charges that are accumulated in a photoelectric conversion element of a photoelectric conversion unit, for example, a photodiode in accordance with incident light in the pixel 100 is transferred to the vertical signal line 130. This embodiment will describe an operation by assuming that the pixel signal is at a high-luminance level. Therefore, the potential of the vertical signal line 130 is at a level corresponding to a high-luminance optical signal. The pixel signal is amplified by the column amplifier 131 and input to the comparator circuit 140. Assume that the amplification factor of the column amplifier is set to 4 at time t3.

At time t4, the potential of the ramp signal rampH is increased to a predetermined threshold voltage indicated by a solid line, thereby performing a decision operation of comparing the potential with the potential of the image signal 135 indicated by the broken line. In this embodiment, the amplification factor of the column amplifier 131 can be selected in accordance with whether the potential is higher or lower than the threshold voltage (threshold). Note that this threshold is preferably set to a voltage whose amplitude is smaller than that of a reaching voltage which the ramp signal rampH whose potential changes from time t7 reaches at time t9 in A/D conversion of the pixel signal (to be described later). According to this embodiment, the operation state of the processing circuit including the amplification factor of the column amplifier can be changed.

In this specification, the amplitude is considered as the absolute value of the difference between the reference voltage value of the change and the changed voltage. That is, in this embodiment, the voltage whose amplitude is smaller than that of the reaching voltage of the ramp signal rampH indicates a voltage having a voltage value lower than the reaching voltage of the ramp signal rampH. By setting the threshold in this way, it is possible to ensure the A/D conversion accuracy with respect to a pixel signal at a level around the reaching voltage of the ramp signal rampH.

If the threshold is set to the same value as the reaching voltage of the ramp signal rampH, when, in A/D conversion thereafter, the amplitude of the image signal 135 becomes large due to external noise, a variation of a power supply voltage, or the like, the image signal 135 may exceed the reaching voltage of the ramp signal rampH. In this case, the output from the comparator 160 remains unchanged, and it is difficult to correctly perform A/D conversion. By setting the threshold to the voltage whose amplitude is smaller than that of the reaching voltage of the ramp signal rampH, the amplification factor of the column amplifier is changed to 1 for the signal level of the image signal 135 around the reaching voltage of the ramp signal rampH, thereby making a decision. This can appropriately perform A/D conversion even for a signal at a level around the reaching voltage of the ramp signal rampH.

In the example shown in FIG. 9, since the incident light has high luminance, the potential of the image signal 135 is higher than the threshold voltage by the ramp signal rampH and the output from the comparator 160 is at H level. At this time, a control signal S1 is set at H level during a period from time t4 to time t5 to allow writing in a holding circuit 320, and H level as the decision result of the comparator 160 is written in the holding circuit 320.

During the period from time t4 to time t5, H level is written in the holding circuit 320. Values written in two holding circuits 320 are sequentially transferred to the memories 215 of the selection units 200 by transfer signals ATX1 and ATX2 during a period from time t5 to t6. Then, by setting a control signal s2 at L level at time t6, the selection unit 200 is allowed to be controlled by the output from the holding circuit 320. In this example, since the incident light has high luminance, the switch 180 is turned on and the switch 190 is turned off. As a result, the amplification factor of the column amplifier 131 is changed from 4 to 1.

During the period from time t5 to time t6, the logic circuit 440 that has received the transfer signal ATX1 or ATX2 writes the decision result in the transfer memory 430.

This embodiment has explained the example in which the amplification factor of the column amplifier 131 is 4 or 1, but the amplification factor is not limited to them. A plurality of thresholds may be provided and an amplification factor selected from a plurality of amplification factors may be set. In this embodiment, since the amplification factor of the column amplifier 131 is changed to 1, the image signal 135 obtained by inverting and amplifying the pixel signal from the vertical signal line 130 with an amplification factor of 1 can be input to the noninverting input terminal of the comparator 160. In addition, since the comparator circuits and the decision circuits are provided in correspondence with the two pixels, as shown in FIG. 8, it is possible to select and set the appropriate amplification factor of the column amplifier for each of the two pixels in accordance with the level of the incident light.

From time t7, the pixel signal corresponding to the high-luminance incident light is A/D-converted. From time t7, the potential of the ramp signal rampH increases and the count signal cnt is counted up. At time t8, the potential of the ramp signal rampH becomes higher than the potential of the image signal 135. When the comparator output transitions to L level at time t8, the result of A/D conversion using the ramp signal rampH for the signal level is written in the memory 340. At time t9, the ramp signal rampH and the count signal cnt are reset. From time t9, information written in the memory 340 is processed, similar to the first embodiment.

### <Example of Application of Photoelectric Conversion Apparatus to Equipment>

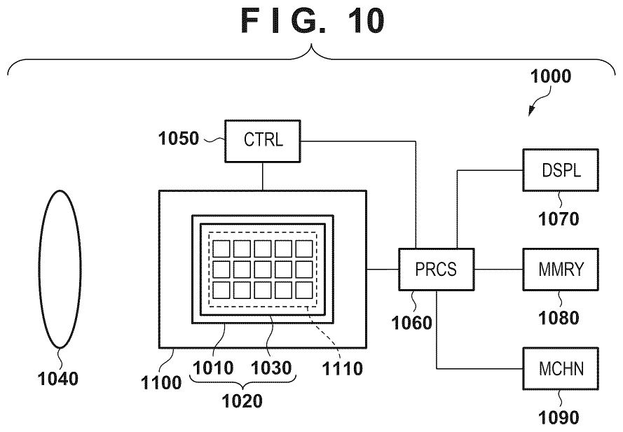

The following is a description of equipment 1000 that includes a semiconductor apparatus 1100 including a package 1020 on which a semiconductor chip 1110 including a semiconductor integrated circuit is mounted, as shown in FIG. 10. The semiconductor chip 1110 is accommodated in the package 1020 and mounted on the equipment 1000. In the arrangement shown in FIG. 10, the semiconductor chip 1110 includes the photoelectric conversion apparatus according to the embodiment described above. The semiconductor apparatus 1100 can include the package 1020 including a base 1010 on which the semiconductor chip 1110 is fixed and a light transmissive member 1030 such as glass that faces the semiconductor chip 1110. The package 1020 can be provided with joining members such as wires and bumps that connect inner leads provided on the base 1010 to terminals such as pad electrodes provided on the semiconductor chip 1110.

The equipment 1000 can include at least one of an optical apparatus 1040, a control apparatus 1050, a processing apparatus 1060, a display apparatus 1070, a storage apparatus 1080, and a mechanical apparatus 1090. The optical apparatus 1040 is implemented by, for example, a lens, a shutter, and a mirror. The control apparatus 1050 controls the semiconductor chip 1110. The control apparatus 1050 is, for example, a semiconductor device such as an ASIC.

The processing apparatus 1060 processes a signal output from the photoelectric conversion apparatus included in the semiconductor chip 1110. The processing apparatus 1060 is a semiconductor device such as a CPU or an ASIC for forming an Analog Front End (AFE) or a Digital Front End (DFE). For example, an image may be generated based on an image capturing signal at the time of detecting an event. The display apparatus 1070 is an EL display device or a liquid crystal display device that displays an information image obtained by the semiconductor chip 1110. The storage apparatus 1080 is a magnetic device or a semiconductor device that stores the information image obtained by the semiconductor chip 1110. The storage apparatus 1080 is a volatile memory such as an SRAM or a DRAM, or a nonvolatile memory such as a flash memory or a hard disk drive.

The mechanical apparatus 1090 includes a moving or propulsion unit such as a motor or an engine. In the equipment 1000, the signal output from the semiconductor chip 1110 is displayed on the display apparatus 1070 or transmitted to an external apparatus by a communication apparatus (not shown) included in the equipment 1000. Hence, the equipment 1000 may further include the storage apparatus 1080 and the processing apparatus 1060 in addition to the memory circuits and arithmetic circuits included in the semiconductor chip 1110. The mechanical apparatus 1090 may be controlled based on the signal output from the semiconductor chip 1110.

The equipment 1000 is suitable for electronic equipment such as an information terminal which has a shooting function, for example, a smartphone or a wearable terminal, or a camera, for example, an interchangeable lens camera, a compact camera, a video camera, or a monitoring camera. The mechanical apparatus 1090 in the camera can drive the components of the optical apparatus 1040 in order to perform zooming, an in-focus operation, and a shutter operation. Alternatively, the mechanical apparatus 1090 in the camera can move the optical apparatus 1040 in order to perform an anti-vibration operation.

Furthermore, the equipment 1000 can be transportation equipment such as a vehicle or a ship. The mechanical apparatus 1090 in the transportation equipment can be used as a moving apparatus. The equipment 1000 as the transportation equipment is suitable for equipment that transports the semiconductor chip 1110 or equipment that uses a shooting function to assist and/or automate drive steering. The processing apparatus 1060 for assisting and/or automating drive steering can perform, based on the information obtained by the semiconductor chip 1110, processing for operating the mechanical apparatus 1090 as a moving apparatus. Alternatively, the equipment 1000 may be medical equipment such as an endoscope, measurement equipment such as a distance measurement sensor, analysis equipment such as an electron microscope, office equipment such as a copy machine, or industrial equipment such as a robot.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2024-074044, filed Apr. 30, 2024, and No. 2025-004336, filed Jan. 10, 2025, which are hereby incorporated by reference wherein in their entirety.

What is claimed is:

1. A photoelectric conversion apparatus comprising:
at least two pixels; and
a processing circuit including at least two comparator circuits each configured to perform a first operation of comparing a pixel signal from a corresponding one of the at least two pixels with a threshold, at least two holding circuits each configured to hold a result of the first operation, and at least two setting units,
wherein each of the at least two holding circuits holds the result of the first operation of a corresponding comparator circuit among the at least two comparator circuits,
the result of the first operation is transferred from each of the at least two holding circuits to a corresponding setting unit among the at least two setting units via a common signal line, and
each of the at least two setting units sets an operation state of the processing circuit in accordance with the result of the first operation.

2. The apparatus according to claim 1, wherein
the setting of the operation state includes setting a reference signal selected from a plurality of reference signals whose voltages change at different change rates with a lapse of time, and
each of the at least two comparator circuits performs a second operation of comparing the pixel signal with the selected reference signal.

3. The apparatus according to claim 1, wherein the at least two pixels are arranged in different rows in a pixel array in which a plurality of pixels are arranged in a matrix.

4. The apparatus according to claim 2, wherein the number of different rows is two, four, or eight.

5. The apparatus according to claim 1, wherein the results of the first operations held in the at least two holding circuits are sequentially transferred to the signal line.

6. The apparatus according to claim 2, further comprising a counter and a memory configured to hold a count value of the counter,
wherein in the second operation, the count value counted during a period until the selected reference signal becomes larger or smaller than a magnitude of the pixel signal is stored in the memory.

7. The apparatus according to claim 1, further comprising an output unit,
wherein the result of the first operation is supplied to the output unit via the signal line.

8. The apparatus according to claim 1, wherein
the processing circuit further includes an amplifier configured to amplify the pixel signal with a set amplification factor, and
the setting of the operation state includes setting the amplification factor.

9. The apparatus according to claim 8, wherein each of the at least two comparator circuits performs a second operation of comparing the pixel signal with a reference signal whose voltage changes with a lapse of time.

10. The apparatus according to claim 8, wherein the at least two pixels are arranged in different rows in a pixel array in which a plurality of pixels are arranged in a matrix.

11. The apparatus according to claim 10, wherein the number of different rows is two, four, or eight.

12. The apparatus according to claim 8, wherein the results of the first operations held in the at least two holding circuits are sequentially transferred to the signal line.

13. The apparatus according to claim 9, further comprising a counter and a memory configured to hold a count value of the counter,
wherein in the second operation, the count value counted during a period until the reference signal becomes larger or smaller than a magnitude of the pixel signal is stored in the memory.

14. The apparatus according to claim 8, further comprising an output unit,
wherein the result of the first operation is supplied to the output unit via the signal line.

15. Equipment comprising:
a photoelectric conversion apparatus defined in claim 1, and
a processing apparatus configured to process a signal output from the photoelectric conversion apparatus.
